(19) United States
(12) Patent Application Publication
(10) Pub. No.: US 2003/0098906 A1
(43) Pub. Date: May 29, 2003

(54) Ink jet transfer printing process

(75) Inventors: Neil A. Randen, Marine St. Croix, MN (US); Scott D. Pearson, Woodbury, MN (US); Lisa M. Miller, Spring Valley, WI (US); Mark E. Fagan, Woodbury, MN (US); David F. Serino, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/277,847

(22) Filed: Oct. 22, 2002

Related U.S. Application Data
(60) Provisional application No. 60/335,252, filed on Oct. 22, 2001.

(51) Int. Cl. B41J 2/01

(52) U.S. Cl. 347/103

(57) ABSTRACT

The invention provides a method for imparting an image to a substrate that includes imparting an image to an image transfer sheet having an image receptive layer releasably attached to a carrier sheet, wherein the imaged side of the image transfer sheet is the side containing the image, and the non-imaged side is the opposite side, contacting the imaged side of the image transfer sheet with the substrate, applying localized pressure to the non-imaged side of the image transfer sheet, and removing the carrier sheet wherein removal of the carrier sheet imparts the portion of the imaged image receptive layer, in a discontinuous fashion, where localized pressure was applied to the non-imaged side of the image transfer sheet.

### CROSS-REFERENCE TO RELATED APPLICATION

This utility application claims priority from U.S. Provisional Application Serial No. 60/335,252 filed on Oct. 22, 2001, which is incorporated herein by reference.

### FIELD OF THE INVENTION

The invention relates generally to articles, methods, and kits for imparting images to a substrate, and in particular to articles, methods, and kits for imparting images to substrates where the image receptive layer is transferred as a discontinuous layer.

### BACKGROUND OF THE INVENTION

The craft industry has shown a strong trend as of late toward customization. Thus, for example, ink jet transfer printing systems are commercially available that allow the personalization of articles of clothing. Images created from such transfers are characterized by an often undesirable filminess in the finished article. Similarly, greeting card stores feature equipment that allows patrons to produce customized greeting cards on the premises. This interest has extended to other items sold by the industry, including decorative wood and ceramic substrates. However, flexography, silk screen, and the other printing techniques commonly used by the industry to produce decorative materials are generally more suitable for large scale production and do not lend themselves to small scale, production of the type required for customized or personalized items.

Transfer ink jet printing methods are well known in the art and involve printing onto a temporary carrier sheet from which the image is subsequently transferred, by lamination, to the final substrate. Transfer printing systems are described, for example, in U.S. Pat. Nos. 5,501,902, 5,798,179, 6,113,725, and 6,200,668. In such systems, an ink jet receptive layer may be combined with a thermally activated adhesive on a temporary supporting sheet. After imaging, the receptor layer, including the image, is transferred under the influence of heat and pressure to the final substrate. However, the use of a thermally activated adhesive is a requirement of such systems, since the sheet must pass through a printer without adhering to the feed mechanism.

Some ink jet transfer printing systems have also been described whereby a thermally activated adhesive is coated on the article that is to receive the final image. A system of this type is described, for example, in U.S. Pat. No. 5,766,398. However, this approach appears to suffer from the infirmities noted above in that the use of a thermally activated adhesive precludes its use on temperature sensitive substrates.

Room temperature transfer systems have been described, see for example U.S. Pat. No. 6,153,038. In accordance with the methodology disclosed therein, an image is first printed on a non-adsorbent medium such as transparency film, with a conventional inkjet printer. The image is then imparted to the target substrate by bringing the surface bearing the image into contact with the target substrate and applying pressure. The target substrate may be provided with a material that will adhere to the surface of the substrate and is sufficiently absorbent or porous such that it will properly receive the ink image.

The approach suggested in U.S. Pat. No. 6,153,038 appears not to require application of heat (only pressure), and can therefore be used to print onto a temperature sensitive substrate. Moreover, the substrate to which the image is to be imparted does not itself have to be passed through the inkjet printer, thus avoiding many of the problems noted above. However, this approach is undesirable in that the printing of the image on the non-adsorbent medium allows the ink to coalesce before the image is imparted to the target substrate, thereby resulting in blurring of the image and an overall reduction in image quality. Moreover, any lateral motion of the non-adsorbent medium during the image application process will cause the image to be smeared. Hence, this approach is not very user friendly.

There is thus a need in the art for a transfer method for imparting graphics to various substrates and articles, which can be used in conjunction with conventional inkjet printers. These and other needs are met by the present invention, as hereinafter described.

### BRIEF DESCRIPTION OF THE DRAWINGS

FIG. 1 is a cross-sectional view of an image transfer sheet in accordance with one aspect of the invention

FIG. 2 is a cross-sectional view of a substrate with a transferred image receptive layer in accordance with one aspect of the invention.

FIG. 3 is a cross-sectional view of an image transfer sheet in accordance with one aspect of the invention.

FIG. 4 is a cross-sectional view of an image transfer sheet in accordance with another aspect of the invention.

FIGS. 5 and 6 are electron microscopic images of examples of image transfer sheets in accordance with the invention.

FIG. 7 is an electron microscopic image of an image receptive layer transferred onto a substrate in accordance with one aspect of the invention.

FIG. 8 is an electron microscopic image of an image receptive layer after the imaged portion of the image receptive layer has been transferred to a substrate in accordance with one aspect of the invention.

### SUMMARY OF THE INVENTION

In one aspect, the present invention relates to a method for imparting an image or images to substrates, products made in accordance with this methodology, and kits for carrying out methods of the invention.

An article for transferring an image to a substrate in accordance with one aspect of the invention comprises a carrier sheet with a top and a bottom surface, and an interrupted image receptive layer releasably attached to the top surface of the carrier sheet. An article for transferring an image to a substrate in accordance with another aspect of the invention comprises a carrier sheet with a top and a bottom surface, and an uninterrupted friable image receptive layer releasably attached to the top surface of the carrier sheet

In accordance with a method of the invention, an image is imparted to an image transfer sheet that comprises an image receptive layer releasably attached to a carrier sheet. The imaged surface of the transfer sheet is then contacted with the substrate, and pressure is applied to the non-imaged side of the image transfer sheet. The carrier sheet is then removed from the substrate, imparting the image and at least a portion of the image receptive layer to the substrate.

The invention also provides a product made using a method of the invention. The product has an image and at least a portion of the image receptive layer transferred to a substrate contained on the substrate.

In accordance with another aspect of the invention, a kit is provided for carrying out a method of the invention. A kit in accordance with the invention comprises a carrier sheet with an image receptive layer releasably attached thereto. Kits in accordance with the invention can also include other compositions and articles for carrying out various methods of the invention.

### DETAILED DESCRIPTION

As used herein, the term “about” applies to all numeric values, whether or not explicitly indicated. The term “about” generally refers to a range of numbers that one would consider equivalent to the recited value (i.e., having the same function or result). In many instances, the term “about” may include numbers that are rounded to the nearest significant figure.

Image Transfer Sheets

Image transfer sheets suitable for use in this invention comprise an image receptive layer, which is releasably attached to a carrier sheet. The image receptive layer and carrier sheets are described in greater detail below.

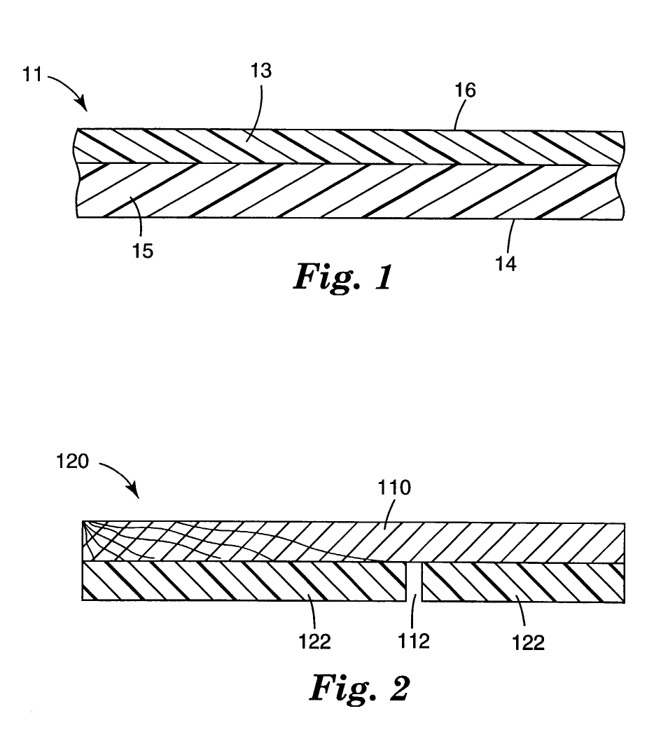

One embodiment of an image transfer sheet 11 in accordance with the invention comprises an image receptive layer 13 releasably coated onto a carrier sheet 15 as seen in FIG. 1. Once imaged, the image transfer sheet 11 has a non-imaged side 14 and an imaged side 16. The carrier sheet 15 has sufficient release properties such that the image receptive layer 13 will release from it when the image receptive layer 13 is pressed against a substrate and localized pressure is applied, but at the same time adheres sufficiently to the image receptive layer 13 so that the image transfer sheet 11 as a whole will not undergo delamination during normal handling or the process of imparting the image to the image transfer sheet 11. The carrier sheet 15 is also preferably selected to provide suitable rigidity, tear resistance, conformability and other desirable physical characteristics to the overall construct. Once the image receptive layer 13 has an image imparted thereto, it is referred to as a printed or an imaged image receptive layer.

Image Receptive Layer

Image receptive layers used in image transfer sheets of the present invention can be a single layer or a laminate of two or more layers. While the description of some of the embodiments of the image receptive layer herein refers to two layers (namely, a bottom surface layer, which is in contact with the carrier sheet, or a release coating that is applied to the carrier sheet, and a top surface layer, which is opposite the bottom surface layer), it is to be understood that the properties of either or both layers can be combined into a single layer, or can be further separated into a greater number of layers. In a preferred embodiment of the invention, the two layers are combined into a single layer. Generally, however, the image receptive layer has a bottom surface capable of providing appropriate release properties to the carrier sheet, and a top surface capable of receiving and fixing an image. It is also preferred that the top surface of the image receptive layer functions to lessen bleeding or spreading of the image that is imaged onto the image receptive layer.

In embodiments where the image receptive layer is a two layered system, the bottom surface layer of the image receptive layer can be constructed from a variety of compositions, and is selected such that it can release from the carrier sheet under normal conditions of use, while at the same time adhering to the carrier sheet sufficiently well so that it does not undergo premature delamination during handling. Compositions suitable for use in these layers include those disclosed in U.S. Pat. Nos. 4,379,804; 4,935,307; 5,045,391; 5,108,865; 5,208,092; 5,342,688; 5,389,723; and 5,747,148. Some specific, non-limiting examples of these materials include poly(vinylpyrrolidone), copolymers of vinylpyrrolidone (e.g., with ethylene or styrene), poly(vinyl alcohol), polyacrylic acids, polymethacrylic acids or (1-alkyl) acrylic acid copolymers and the inorganic salts thereof (such as the alkali metal salts), poly(alkylene oxides) or polyglycols, carbohydrates, alkyl and hydroxyalkyl cellulose derivatives, starch and starch derivatives such as hydroxyalkyl starches, carboxyalkyl celluloses and their salts, gum arabic, xanthan gum, carageenan gum, proteins and polypeptides. In another embodiment of the invention, a release layer can be applied to the carrier sheet to aid in the release of the image receptive layer from the carrier sheet. In such an embodiment, the release properties of the image receptive layer may be less important. An example of a material suitable for use in a release layer would be a polydimethyl siloxane polymer.

The top surface layer can be constructed from a variety of compositions, provided it can adhere to a substrate under appropriate transfer conditions and can receive an image. The top surface layer may include various ink jet receptive coatings as are known in the art, such as the compositions called ink jet receptor layers in U.S. Pat. No. 5,747,148. Suitable ink jet receptive coatings may be of the microporous or swellable polymer type. Microporous image receptor coatings, and in particular ink jet receptive coatings, are described, for example, in U.S. Pat. Nos. 5,264,275 and 6,037,050, and typically include one or more composite layers comprising a binder material and inorganic particles such as silica or alumina. The particles are arranged in the binder material such that voids between the particles provide porosity.

Swellable polymer type ink jet receptive coatings may also be used in the present invention. Such materials are described, for example, in U.S. Pat. Nos. 5,342,688 and 5,389,723. Swellable polymer type ink jet receptive coatings typically comprise one or more hydrophilic polymers such as gelatin, polyvinyl alcohol, polyvinylpyrrolidone, copolymers of vinyl pyrrolidone (e.g., with ethylene or styrene), polyacrylic acid derivatives, (1-alkyl) acrylic acid copolymers and the inorganic salts such as alkali metal salts derived there from, cellulose derivatives, including alkyl and hydroxylalkyl cellulose derivatives, polysaccharides, carbohydrates, starch and starch derivatives such as hydroxyalkyl starches, carboxyalkyl celluloses and their salts, gum arabic, xanthan gum, carageenan gum, proteins and polypeptides, poly(alkylene oxides), polyethylene oxides, polyglycols, and polyalkyloxazolines.

Swellable polymer coatings may optionally be cross-linked by a chemical or physical cross-linking agent, and may contain additional additives such as inorganic or organic matting agents, surfactants, humectants, biocides, fillers, UV absorbers, image dye stabilizers, and other such additives. Suitable image receptive layers may comprise single layers or multiple layer coatings. In the case of multiple layer coatings, the layer that is in contact with the carrier sheet may serve the purpose of a protective outer layer after the image is transferred. Such a construction is described, for example, in U.S. Pat. No. 5,766,398. The dried thickness of the image receptive layer is typically from about 1 to about 5 micrometers, more preferably from about 1 to about 4 micrometers and most preferably from about 1 to about 3 micrometers.

As noted above, the image receptive layer can include dispersed particles or particulates according to the disclosure of U.S. Pat. No. 5,747,148. Non-limiting examples of such dispersed particles or particulates include corn starch or modified corn starches, silica, alumina, titanium dioxide or other white inorganic oxide or hydroxide materials, cotton or flock particles and other cellulose or modified cellulose particulates, calcium carbonate or calcium silicate and other white inorganic silicates, sulfides and carbonates, clays, and talc. The size of the dispersed particles or particulates are typically in the range of about 1 to about 40 micrometers in diameter, preferably in the range of about 1 to about 10 micrometers in diameter. However, the present invention is not particularly limited to any range of particle sizes, so long as there are sufficient particles having sizes large enough to roughen the upper surface of the top surface layer. Particles and/or particulates are typically added into solution for the image receptive layer in the range of about 10 to about 60% by weight of total solids, preferably in the range of about 15 to about 25% by weight of total solids.

Image receptive layers in accordance with the invention may also include various mordants as are known to those of skill in the art. However, the preferred mordants are polymeric mordants comprising a guanidine functionality having the following general structure:

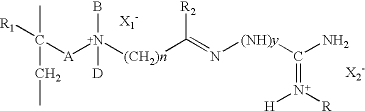

wherein

A is selected from the group consisting of a COO-alkylene group having from about 1 to about 5 carbon atoms, a CONH-alkylene group having from about 1 to about 5 carbon atoms, —COO—(CH₂CH₂O)ₙ-CH₂— and —CONH—(CH₂CH₂O)ₙ-CH2—, wherein n is from about 1 to about 5;

B and D are independently separately selected from the group consisting of alkyl group having from about 1 to about 5 carbon atoms;

or A, B, D and N are combined to form a heterocyclic compound selected from the group consisting of

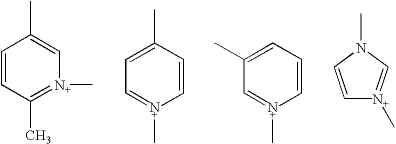

wherein

R₁ and R₂ are independently selected from the group consisting of hydrogen, phenyl, and an alkyl group containing from about 1 to about 5 carbon atoms;

R is selected from the group consisting of hydrogen, phenyl, benzimidazolyl, and an alkyl group containing from about 1 to about 5 carbon atoms,

y is selected from the group consisting of 0 and 1, and

X₁ and X₂ are anions.

Image receptive layer compositions in accordance with the invention can also include one or more surfactants. Surfactant(s) can function to make the image receptive layer easier to coat evenly onto the carrier sheet. Any surfactants known to those of skill in the art to improve the wettability of such compositions can be utilized. If utilized in image receptive layers of the invention, surfactants are generally added at a level of from about 0.05% to about 1.0% preferably from about 0.1% to 0.4% by weight.

The dried coating weight of the image receptive layer is typically between about 1 to about 5 g/m², preferably between about 1 and about 3.7 g/m² and most preferably between about 1 and about 3 g/m².

Image receptive layers in accordance with the invention can be uninterrupted and friable, interrupted and friable, or interrupted and nonfriable. As used herein, an image receptive layer that is uninterrupted is one in which the material that makes up the image receptive layer is maintained, without interruption of areas with no image receptive layer material over the surface area of interest of the carrier sheet. An uninterrupted image receptive layer can have varying thicknesses, but at no point over the surface area of interest of the carrier sheet, can the image receptive layer not be present. As used herein, an image receptive layer that is interrupted is one in which the material that makes up the image receptive layer is not present at one or more areas on the portion of the surface of the carrier sheet that corresponds to the area where the image is to be applied. In an interrupted image receptive layer, the interruptions in the image receptive layer material can be caused by the coating technique, or the surface that was coated for example. As used herein, an image receptive layer that is friable is one in which the material of the image receptive layer, as it is applied to the carrier sheet, can be fractured when the imaged image receptive layer is transferred to the substrate.

Transfer of any image receptive layer of the invention onto a substrate transfers the imaged image receptive layer as a discontinuous layer. As used herein, a discontinuous imaged image receptive layer describes an imaged image receptive layer that is physically separated or split after transfer, but in which such physical separations are less than about 250 micrometers, preferably less than about 150 micrometers, more preferably less than about 50 micrometers. It should be noted that the image receptive layer can, but need not contain the same physical separations before transfer.

FIG. 2 depicts a portion of a transferred image 120 in accordance with one aspect of the invention. In FIG. 2, an imaged image receptive layer 122 has been transferred to a substrate 110. As can be seen in FIG. 2, the transferred image receptive layer 122 includes at least one physical separation 112. The at least one physical separation 112 could have been caused either by an uninterrupted friable image receptive layer fracturing upon transfer, by the interruptions in an interrupted image receptive layer, by an interrupted friable image receptive layer further fracturing upon transfer, or by some combination thereof.

In one embodiment of the invention, the image receptive layer is uninterrupted and friable. During the transfer step, this uninterrupted and friable layer fractures, to a degree, and the transferred imaged image receptive layer may give the appearance (if observed with something more powerful than the naked eye) of sheets of discrete tiles or portions of the imaged image receptive layer having been transferred.

Uninterrupted friable layers may provide advantages versus uninterrupted nonfriable layer, for example, the ability of the image receptive layer to split along thinner areas of the image receptive layer and to selectively transfer only the areas where localized pressure was applied. This can minimize puckering, wrinkling and reduce excessive non-imaged film transfer (“ghosting”) or edge effects in the transferred image receptive layer that may result with a nonfriable uninterrupted layer. Furthermore, use of a friable layer allows the edge of the areas where ghosting appears to be easily removed by rubbing the areas lightly, for example by rubbing lightly with an eraser. Friable image receptive layers may also provide an advantage in that the physical separations in the transferred image receptive layer can allow air to escape from under the transferred film thus reducing or eliminating trapped air bubbles.

Embodiments of the invention that utilize a friable image receptive layer can utilize any composition known to those of skill in the art as one that is friable under the coating and/or transfer conditions employed. In one embodiment of the invention, a material for the image receptive layer can include any of the compositions discussed above and further include a humectant. One example of a humectant that can be used in embodiments of the invention includes glycerol. It is thought that the humectant, such as glycerol, acts as a plasticizer which gives the image receptive layer more film integrity so that during normal handling and imaging of the image receptive layer, damage is not done to the image receptive layer. It may also soften the imaged image receptive layer which increases the affinity of the image receptive layer for the substrate. In addition, the inclusion of a humectant generally allows a more vibrant image to be transferred.

In compositions where glycerol is utilized as the humectant, it is present in an amount of from about 0.5 to about 20% by weight of total dried solids, preferably from about 2.5 to about 10% by weight of total dried solids, and more preferably about 5% by weight of total dried solids.

In yet another embodiment of the invention the image receptive layer is interrupted. In such embodiments, the layer may be friable or nonfriable. Transfer of such an image receptive layer results in the transfer of a discontinuous layer of imaged image receptive layer. The transferred layer will have areas that have splits or fractures in the material or have areas where there was no image receptive layer transferred. Interrupted image receptive layers, whether friable or nonfriable may provide the same advantages as the uninterrupted friable layer can.

Interrupted image receptive layers can either be prepared by the coating technique utilized, or the surface that is coated. Interrupted image receptive layers prepared by the coating technique can be prepared by any pattern coating method known to those of skill in the art. In such embodiments, the image receptive layer is generally pattern coated onto a smooth carrier sheet. The image receptive layer can be pattern coated in any configuration as long as the image receptive layer has portions of the surface area of interest of the carrier sheet that are not coated with the image receptive layer material. Any geometric configurations, or other configurations used by those of skill in the art for pattern coating may be used. Interrupted image receptive layers can also be prepared by coating a smooth coating of the image receptive layer material onto a carrier sheet with a patterned surface. Carrier sheets that can be utilized in these embodiments are discussed in more detail below.

Carrier Sheet

Image transfer sheets of the invention also comprise a carrier sheet. A variety of conventional carrier sheets can be used in practicing the methodology of the invention. The carrier sheet may be a sheet of any material that has suitable flexibility and rigidity to pass, unsupported, through the feed mechanism of common ink jet printers. Suitable carrier sheets are typically from about 0.05 to about 0.75 mm thick, and most preferably from about 0.05 to about 0.15 mm thick. The carrier sheet is preferably constructed such that the adhesion between the carrier sheet and the image receptive layer is sufficiently low to allow transfer of at least a portion of the image receptive layer to a substrate. This may be accomplished through appropriate selection of the carrier sheet materials, by coating the carrier sheet with a release coating, or through selection of the materials of the bottom layer of the image receptor. When embodiments that include a release coating on the carrier sheet are transferred to the substrate, the majority of the release coating remains with the carrier sheet, and the image receptive layer is transferred to the substrate. Suitable carrier sheet constructions include those described, for example, in PCT Intl. Pub. No. WO 00/02735, which is incorporated by reference herein in its entirety.

Non-limiting examples of such carrier sheets include coated (alkyd and acrylic) and uncoated paper liners, paper laminates, and plastic films, including those comprising polyester, polystyrene, polyethylene, polypropylene, and other polyolefins, and polyethylene terephthalate.

In general, the carrier sheet material and construction should be chosen so that, under the conditions of transfer, the top surface layer which comes into contact with the receiving substrate will adhere to the receiving substrate better than the layer directly adjacent to the carrier sheet. In some embodiments of the invention, the backside of the carrier sheet may also be provided with a release layer to prevent transfer of the image receptor layer from the front side of the carrier sheet to the backside of the carrier sheet when the image transfer sheet is stored in roll form.

For purposes of manufacturing and handling, the carrier sheet will typically have a thickness of from about 0.05 to about 0.75 mm, and preferably from about 0.05 to about 0.15 mm.

For purposes of assuring good release of the image receptive layer from the carrier sheet at the time of transfer to a substrate, the carrier sheet has a surface such that the adhesion between it and the image receptive layer under the conditions of transfer is greater than about 0 lb/in (0 N/m) but less than the cohesive strength or the force required for elongation of the image receptive layer, which in many cases will be less than about 5 lb/in (about 900 N/m). The critical surface tension of the substrate will typically be within the range of about 20-60 dynes/cm, although this will be heavily dependent on the particular chemistry of the image receptive layer. The effective release area may cover the entire carrier sheet, or a release layer may be pattern coated on the carrier sheet in order to create portions of the image receptive layer that will be transferred. There is no particular limit to the area of the carrier sheet. However, for most practical applications, the width of the carrier sheet will range from about 2 cm to about 2 m.

Image transfer sheets in accordance with the invention may also comprise a carrier sheet that is micro-embossed. A carrier sheet that is micro-embossed has a surface topography that in its most general sense is not planar.

In general, the choice of geometrical configuration of the specific micro-embossed features of the carrier sheet does not greatly influence image transfer performance. In some preferred embodiments, the geometrical configuration is chosen such that the micro-embossed element pitch (i.e., center to center distance between micro-embossed elements) is less than about 340 micrometers. In further preferred embodiments, the micro-embossed element density of the pattern is such that the cavity walls actually collapse when moderate pressure is applied i.e., that applied by hand, to effect the transfer of the image.

For example, low density polyethylene walls micro-embossed as an orthogonal grid and having an average wall thickness of about 10 to about 25 micrometers, spaced with a micro-embossed element pitch of about 338 micrometers, and having square wells with a depth of about 25 micrometers, completely collapse during image transfer with moderate hand pressure. On the other hand, the same low density polyethylene material micro-embossed with an orthogonal grid pattern with walls about 10 to about 25 micrometers thick, spaced with a micro-embossed element pitch of about 127 micrometers, and having square wells with a depth of about 25 micrometers do not collapse. In general, image transfer sheets with carrier sheets having collapsible features are superior to those containing more rigid features.

In one embodiment, the micro-embossed imaging surface itself has release properties, that is, the micro-embossed surface has a surface energy that facilitates the transfer of imaged image receptive layer from the surface topography without any additional release coating added. The imaging surface of the sheet is also preferably nonporous as defined above.

The peaks of a micro-embossed carrier sheet may be any protruding geometric shape, for example, circular, oval, trapezoidal, spiral, square, triangular, octagonal, and the like. Preferably, the space between posts is from about 10 to about 1000 micrometers, even more preferably from about 50 to about 800 micrometers and even more preferably from about 200 to about 600 micrometers. Preferably, the height of the posts ranges from about 5 to about 100 micrometers, more preferably from about 10 to about 70 micrometers, even more preferably from about 10 to about 40 micrometers. Preferably, the diameter of the posts ranges from about 10 to about 150 micrometers, more preferably from about 10 to about 100 micrometers and even more preferably from about 30 to about 90 micrometers. Preferably, the density of the posts ranges from about 1 to about 40 posts per square millimeter, more preferably from about 2 to about 20 posts per square millimeter and even more preferably from about 2 to about 10 posts per square millimeter. A release coating may also be coated onto the micro-embossed surface of the carrier sheet.

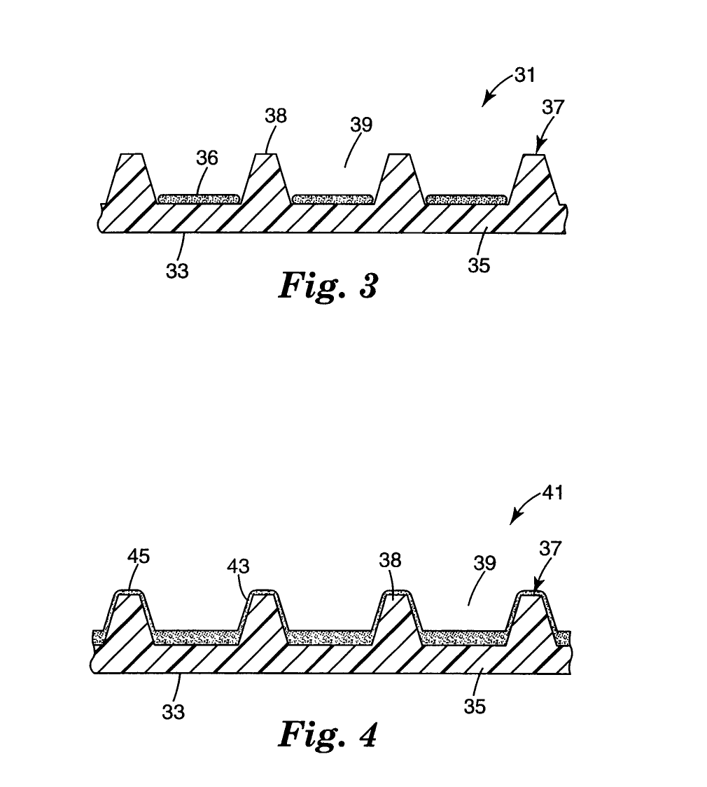

FIG. 3 depicts one embodiment of an image transfer sheet 31 that includes a micro-embossed carrier sheet 33. The micro-embossed carrier sheet 33 is constructed of a sheet 35 having a micro-embossed surface topography 37 of wells 39 and peaks 38. The micro-embossed carrier sheet 33 is coated with an image receptive layer material so that the material collects only in the wells 39, to form an interrupted image receptive layer made of tiles 36.

FIG. 4 depicts another embodiment of an image transfer sheet 41 that includes a micro-embossed carrier sheet 33 as described with respect to FIG. 3 where applicable. In this embodiment, the micro-embossed carrier sheet 33 is coated with an image receptive layer material so that the material coats both the wells 39 and the peaks 38, creating an uninterrupted image receptive layer 43. Although the uninterrupted image receptive layer 43 may have different thicknesses at different points, it is still an uninterrupted image receptive layer, as the term is used herein. In accordance with the invention, the uninterrupted image receptive layer 43 would be a material that is friable under the conditions of coating and transfer. Therefore, when the image receptive layer 43 is transferred to a substrate, it is more likely to fracture at the crowns 45, than at other locations within the image receptive layer.

Any method known to those of skill in the art for coating the carrier sheet with the image receptive layer can be utilized. The following is a list of typical conditions that can be used to coat the image receptive layer onto the carrier sheet:

(a) type of coating: dip roll, meter roll, slot die (with or without vacuum), cross flow knife, notched bar, gravure, air knife;

(b) web speed range: about 1 to about 100 and preferably about 50 m/min;

(c) dried coating weight range: about 1 to about 5 g/m² and preferably about 1 to about 3.7 g/m²;

(d) percent area of carrier sheet covered: about 10 to about 99%, and preferably about 95%;

(e) concentration of image receptive layer coating solution: about 0.5 to about 40%, and preferably about 1.0 to about 3.0% (all weight percents).

The thickness of the image receptive layers coated onto a micro-replicated carrier sheet will depend at least in part on the dimensions of the embossed microstructure thereon. On a more deeply embossed structure, a thicker layer of the ink-receptive coating can be applied and on a shallowly embossed microstructure, less would be required. Preferably, the image receptive layer will be thick enough to absorb the image applied thereto and dry within about 10 minutes. A preferred embossment structure would be about 200 micrometer squares about 10 micrometers deep into the film.

Substrate

The substrate can be any single layer or multilayer composite according to the requirements of use. Non-limiting examples of substrates suitable for use in the practice of the present invention include cellulosic substrates, including naturally and synthetically-modified cellulosics, polyvinyl chlorides, solid and microvoided polyesters, polyolefins, polycarbonates, polyacrylates, polyacrylate esters, and copolymers thereof, including ionomers (e.g., Surlyn™ brand ionomer from DuPont of Wilmington, Del., USA), metal foils such as aluminum foil, plastic films and sheeting, and latex substrates, ceramics, glass, rubbers, metals, papers, wood (all of the previous may be finished, unfinished, or painted). Examples of modified-polyolefins suitable for use in the present invention are disclosed in U.S. Pat. No. 5,721,086. Any of these substrates may take a variety of forms, including sheets, boxes, bags, and other substantially two-dimensional articles, and three-dimensional articles. Useful substrates can be transparent, translucent, or opaque. Useful substrates can be adhesive-backed, fastener-backed, or neither.

To facilitate the practice of the present invention, two or more items suitable for implementing the methodology of the present invention may be grouped together and sold as a kit. Thus, for example, a wood plaque or balloon prepared in accordance with the invention may be sold in conjunction with a plurality of image transfer sheets, thereby allowing the consumer to experiment with multiple designs.

In one embodiment of the present invention a substrate is provided with at least one patch of pressure sensitive adhesive corresponding at least in size and shape to the image being transferred. Alternatively, multiple patches may be provided on the substrate. The adhesive patch is protected from contact prior to use by a releasable backing sheet. Transfer of the image to the substrate is carried out by removal of the protective backing sheet from the adhesive patch, followed by lamination of the image transfer sheet, image side down, to the adhesive patch. After application of moderate pressure, the temporary carrier sheet is peeled away, leaving the imaged layer in place on the substrate.

In another aspect of the present invention transfer of the image is accomplished without the use of adhesive: A substrate is provided that has preferably been previously primed and transfer of the image to the substrate is carried out by positioning the imaged transfer sheet, image side down, onto the primed surface. After application of moderate pressure, such as by rubbing the backside of the transfer sheet with a wood craft stick, the temporary carrier sheet is peeled away, leaving the imaged layer in place on the substrate. The main advantages of accomplishing the transfer without an adhesive are in simplifying the transfer process by eliminating the need to shape, handle and align the adhesive patch, improving the control of the transfer process since only the areas rubbed are transferred, and by greatly improving the appearance and integration of the transferred image on the substrate; i.e., a less “sticker-like” transfer that occurs with adhesive systems due to the additional thickness of the adhesive patch under the transferred image.

The adhesive patch preferably comprises a suitable pressure sensitive adhesive. A pressure sensitive adhesive is a material, which adheres using applied finger pressure, and is permanently tacky. Pressure sensitive adhesive formulations are described, for example, in Satas, Ed., “Handbook of Pressure Sensitive Adhesives”, 2^{nd} Ed., Von Nostrand Reinhold 1989, and in U.S. Pat. Nos. 2,973,826, 4,112,213, and 5,670,557. Pressure sensitive adhesives typically comprise an elastomer polymer such as natural or synthetic rubber, acrylic polymers and copolymers, or styrene butadiene copolymers. The adhesive composition typically contains one or more of the following additives: tackifying additives, cross-linking agents, fillers, antioxidants and stabilizers.

The pressure sensitive adhesive may be applied to the substrate as a liquid coating, which is subsequently dried. The pressure sensitive adhesive may also be applied directly to the imaged image receptive layer, and similarly dried. The liquid coating of adhesive may for example be sprayed on in either case. A suitable spray adhesive is available from 3M Co. under the brand-name Photo Mount® spray adhesive. The preferred method of application of the adhesive patch to the substrate is by transfer of an adhesive layer that is precoated on a releasable backing sheet. Suitable examples of a coated adhesive layer on releasable backing sheet are available from 3M Co. under the brand-name Scotch® adhesive transfer tape.

In the case that the adhesive is applied using a 3M, or other brand, of adhesive transfer tape, the releasable backing sheet that is supplied with the adhesive may simply be left in place until the substrate is to receive the transfer printed image. Releasable backing sheets, a.k.a. release liners, are well-known and are available from a number of sources. Examples of releasable backing sheet materials include silicone coated kraft paper, silicone coated polyethylene paper laminates, and the like. Improved release from the adhesive layer may be achieved by a further treatment of the releasable backing sheet with polymeric release agents such as silicone urea resins, urethanes and long chain acrylates, described, for example, and U.S. Pat. Nos. 3,957,724, 4,567,073, and 5,290,615.

In one embodiment of the invention, a surface of the substrate can be additionally prepared for receiving an image and the transferred portion of the image receptive layer. A surface may be prepared for example by smoothing, e.g., sanding of an unfinished wood surface and removal of the dust followed by sealing with a primer. In some cases, it is advantageous to prepare the surface of the substrate for receiving the adhesive, to ensure an optimal bond. The surface may be prepared, for example, with a primer or by abrading the surface sufficiently to roughen or texture it. The surface may also be prepared with a corona discharge treatment. With respect to the later, a range of about 0.5 J/cm² to about 2 J/cm² has been found to be useful for adhesion promotion at a web speed of about 15 meters per minute, with a preferred range of about 1.0 J/cm² to about 1.5 J/cm².

Primer on Receiving Substrate

In another embodiment of the invention, a substrate, such as a wooden plaque etc., to which the printed image is being transferred, can be primed to facilitate the image transfer process. The primer can serve to seal the surface and/or enhance acceptance of the transferred imaged image receptive layer. It can also be an ink-receptive coating, or a film-forming composition such as shellac and the like. These primers can be applied as is known to those of skill in the art, for example by brushing them onto said substrates and allowing them to dry for about 20 minutes. The transfers are then executed as described earlier.

In one embodiment of the invention, the primer is an ink receptive solution. Preferably the ink receptive solution comprises a cosolvent. Generally, the cosolvent functions to level the primer during drying. Any cosolvents that are known to those of skill in the art to function with the ink receptive solution can be utilized, examples of which include n-propanol, isopropyl alcohol, and the like.

In embodiments utilizing a primer that functions as an ink receptive coating that includes isopropyl alcohol or n-propanol, they are generally present in an amount between about 25 and about 400% by weight of the ink receptive coating components (excluding water), preferably between about 50 and about 150% by weight of the ink receptive coating components (excluding water), and more preferably between about 75 and about 125% by weight of the ink receptive coating (excluding water).

Articles of the Invention

The invention provides articles for transferring an image to a substrate that comprise a carrier sheet with a top and a bottom surface, and an interrupted image receptive layer releasably attached to the top surface of the carrier sheet. In one embodiment, the carrier sheet is micro-embossed. One method of a micro-embossed carrier sheets includes wells. The wells generally have a depth of from about 5 to about 100 micrometers, preferably from about 10 to about 25 micrometers. In one embodiment, an example of which is depicted in FIG. 3, the image receptive layer is made of tiles that exist in the wells of the micro-embossed features of the carrier sheet. The image receptive layer can be either friable or nonfriable in these embodiments. In embodiments where the image receptive layer is friable, the composition preferably comprises a humectant, more preferably glycerol. In embodiments where the image receptive layer comprises tiles, the image receptive layer is generally coated at a dried weight of about 1 to about 2 gm/m². In further embodiments, the image receptive layer can also be interrupted by being pattern coated onto a carrier sheet. In yet another embodiment, the article can further comprise an image that has been applied to the image receptive layer, preferably with an ink jet printer.

Another embodiment of the invention provides different articles for transferring an image to a substrate that comprise a carrier sheet with a top and bottom surface, and an uninterrupted friable image receptive layer releasably attached to the top surface of the carrier sheet. In one embodiment, the carrier sheet is micro-embossed. One method of a micro-embossed carrier sheets includes wells. The wells generally have a depth of from about 5 to about 100 micrometers, preferably from about 10 to about 25 micrometers. An example of an embodiment with a micro-embossed carrier sheet and an uninterrupted image receptive layer can be seen in FIG. 4. The image receptive layer in an article in accordance with this aspect of the invention is friable. Friable compositions as are known to those of skill in the art that would function as the image receptive layer can be utilize, preferably the composition comprises a humectant, more preferably glycerol. In embodiments where the image receptive layer is uninterrupted and friable, the image receptive layer is generally coated at a dried weight of about 2 to about 3.7 gm/m². In further embodiments, the uninterrupted friable image receptive layer can be releasably attached to a carrier sheet, such as one that is not micro-embossed. In yet another embodiment, the article can further comprise an image that has been applied to the image receptive layer, preferably with an ink jet printer.

Articles of the invention can also include any of the other alternative components discussed with respect to the invention as a whole.

Kits of the Invention

The invention provides kits for transferring an image to a substrate comprising an image transfer sheet that comprises an image receptive layer releasably attached to a carrier sheet wherein the image receptive layer and the carrier sheet are configured to transfer a portion of the image receptive layer, as a discontinuous layer, to the substrate. Carrier sheets in kits of the invention can, but need not be micro-embossed, and if the carrier sheet is micro-embossed, micro-embossed elements, called wells can be present. In one embodiment, the wells have a depth of from about 5 to about 100 micrometers, preferably from about 10 to about 25 micrometers. The image receptive layer can be comprised of tiles that are within the wells of the micro-embossed carrier sheet. Alternatively, the image receptive layer can be uninterrupted. Uninterrupted image receptive layers are also friable, and can be, but need not be releasably attached to micro-embossed carrier sheets. Friable compositions as are known to those of skill in the art that would function as the image receptive layer can be utilize, preferably the composition comprises a humectant, more preferably glycerol. In embodiments where the image receptive layer comprises tiles, the image receptive layer is generally coated at a dried weight of about 1 to about 2 gm/m². In further embodiments, the uninterrupted friable image receptive layer can be releasably attached to a carrier sheet, such as one that is not micro-embossed. In yet another embodiment, the article can further comprise an image that has been applied to the image receptive layer, preferably with an ink jet printer.

Kits in accordance with the invention can also comprise a primer for application to the substrate before the image is transferred. Alternatively, kits of the invention can also comprise an adhesive composition, either for application to the image transfer sheet before transfer or for application to the substrate before transfer. Kits in accordance with the invention can also comprise a topcoat or sealant for application to the substrate after the image has been transferred, the topcoat or sealant can function to enhance either the stability of the transferred image, or the aesthetic qualities thereof.

Kits of the invention can also include any of the other alternative components discussed with respect to the invention as a whole.

Methods of the Invention

The invention provides methods of transferring images to a substrate. Generally, a method in accordance with the invention comprises imparting an image to an image transfer sheet having an image receptive layer releasably attached to a carrier sheet, contacting the imaged side of the image transfer sheet with the substrate, applying localized pressure to the non-imaged side of the image transfer sheet, and removing the carrier sheet wherein removal of the carrier sheet imparts the portion of the imaged image receptive layer, as a discontinuous layer, where localized pressure was applied to the non-imaged side of the image transfer sheet. In one embodiment, the localized pressure is applied only to the non-imaged side of the image transfer sheet corresponding to the portion of the image transfer sheet that contains the image. In another embodiment of the invention, the localized pressure is applied using a craft stick or tongue depressor.

In accordance with one aspect of the invention, at least one desired image is first printed onto the image receptive layer of the image transfer sheet using a conventional ink-jet printer, or is drawn by hand using, for example, solvent markers. The image is allowed to dry sufficiently so that when contacted to a substrate it does not smudge under light pressure. The drying time will depend on the method of printing the image. The imaged side of the image transfer sheet is then contacted to the substrate. The image transfer sheet is held in place, for example, with hand pressure or taping around the perimeter, to eliminate shifting of the image transfer sheet relative to the substrate while rubbing the non-imaged side of the image transfer sheet. Localized pressure is applied on the non-imaged side of the image transfer sheet in order to insure intimate contact between the image transfer sheet and the substrate. In one embodiment, the localized pressure is applied only where the printed image lies. The carrier sheet is peeled away, leaving the portion of the imaged image receptive layer, as a discontinuous layer, where localized pressure was applied to the non-imaged side of the image transfer sheet. Excess image receptive layer transferred around the edge may be removed if desired by gently brushing it with fingers or erasing lightly with an eraser. This method relies at least in part on the imaged image receptive layer having a greater affinity to adhere to the substrate than to the carrier sheet.

In accordance with another aspect of the invention, a primer can be applied to the substrate and allowed to dry before the image is transferred thereto. The primer may provide added anchorage of the imaged image receptive layer to the substrate as well as preferably bind and fix the inks of the image. The imaged image transfer sheet is positioned over the primed area and allowed to make contact. While the image transfer sheet is prevented from shifting relative to the substrate, localized pressure is applied to the non-imaged side of the image transfer sheet, for example by rubbing with a tongue depressor (i.e., craft stick) in order to insure intimate contact and transfer of the image. The carrier sheet is peeled away leaving the printed image and at least a portion of the imaged image receptive layer, as a discontinuous layer, where localized pressure was applied to the non-imaged side of the image transfer sheet.

In yet another embodiment of the invention, an adhesive is applied to the imaged side of the image transfer sheet after the image has been applied thereon. The adhesive coated image transfer sheet is contacted to the substrate and localized pressure is applied to the non-imaged and non-adhesive side of the image transfer sheet in order to insure intimate contact. The carrier sheet is peeled away leaving the printed image and at least a portion of the imaged image receptive layer, as a discontinuous layer, where localized pressure was applied to the non-imaged side of the image transfer sheet

In a further embodiment of the invention, an adhesive can be applied to the substrate. The imaged image transfer sheet is then contacted to the adhesive coated substrate and localized pressure is applied to the non-imaged side of the image transfer sheet in order to insure intimate contact. The carrier sheet is then peeled away leaving the image and at least a portion of the imaged image receptive layer, as a discontinuous layer, where localized pressure was applied to the non-imaged side of the image transfer sheet.

In even a further embodiment of the invention, an additional coating layer or layers are applied over the imaged image transfer sheet in order to impart a decorative attribute which cannot be achieved through conventional ink-jet printing processes. These additional layers can also be applied to the substrate either before or after transfer of the image to the substrate. For example, additional layers could create a background for a printed image. This additional layer or layers can be opaque in order to a) create a solid colored background against which the color from the translucent inks from desk top ink jet printers becomes more vivid and less distorted by the color of the surface upon which they are applied, and b) if white in color, provide a method for creating white color in images printed from typical desk top ink jet printers, which by nature of their technology do not have the capability of producing white. The additional layer or layers can also provide other enhancements to the appearance of the finished image that cannot be created through the particular printing process that is utilized. These enhancements may include pearlescent, glitter, or reflective background effects for example.

In another embodiment of the invention, a topcoat or sealant can be applied to the transferred image to protect the final transferred image on the substrate. The topcoat or sealant can protect the image from degradation due to forces such as abrasion, UV degradation, humidity, or the like.

Inks

A wide variety of inks may be used in practicing the methodologies of the present invention. These include any ink that is available from the printer manufacturer for conventional ink jet printing. Such inks commonly comprise a liquid carrier, dyes or pigments, humectants, organic solvents, biocides, and agents to control rheology and surface tension. The inks may or may not be water-soluble. Suitable inks include high pigment density inks that allow for brighter colors without the need to applying heavy or multiple coats. Suitable inks also include higher viscosity inks. Suitable inks may also be from markers and the like.

Printing Devices and Methodologies

A variety of a printing devices and methodologies may be used to impart an image to the image receiving layers in accordance with the present invention. These include, for example, flexography and silkscreen methodologies. However, the preferred methodology for imparting an image to the image receiving layer is through the use of conventional printers, such as ink jet printers or laser printers, or such other printers as are capable of printing a black and white, single color, or full-color image. Examples of suitable ink jet printers include Hewlett Packard DeskJet ink jet printers, Canon bubble jet ink jet printers, Lexmark ink jet printers, and Epson ink jet printers.

While the method of printing an image onto an object in accordance with the present invention can vary significantly, the following are the steps involved in a typical embodiment:

1. A mirror image of the desired graphic is printed onto the image receptor/ink absorptive layer side of the image transfer sheet, using an ink jet printer.

2. The image is allowed to dry for at least about 10 and up to about 30 minutes.

3. The substrate to be transferred onto is coated with a primer such as a preferably ink-receptive primer and/or an adhesive. If necessary, the primer coating is allowed to dry completely.

4. The printed side of the image transfer sheet is applied to the, primed substrate, and secured in place by either hand or taping around the perimeter to prevent shifting during the transfer.

5. The primed substrate, for example a wood or ceramic piece, is contacted with the imaged side of the image transfer sheet, and localized pressure is applied to the non-imaged side of the image transfer sheet.

6. The temporary carrier sheet is carefully peeled away from the ink absorptive layer, removed and discarded.

Image Sources

The images to be imparted to the various substrates in accordance with the present invention may come from a variety of sources. Thus, for example, the images may be input into a computer with a scanner, by the use of a digital camera, by downloading an image from a remote source (such as from a disk, a network, or the Internet), or by creating a new image on the computer with an appropriate software package. Prior to printing the selected image onto the image receiving layer, the image may be manipulated, as by adjusting the brightness, colors, contrast, orientation, size, background, foreground, shape and various other visual attributes of the image prior to printing. A variety of image manipulation computer programs are available that are suitable for these purposes. These include, for example, Adobe PageMaker, Adobe Photoshop, Adobe Illustrator, 3M Graphic Maker Ink Jet Software (available from Minnesota Mining and Manufacturing Company), PhotoSmart (available from Hewlett Packard), Hemera Graphics Desk for HP, Corel PhotoHouse 5, and the like. Images may also by drawn by hand, or combined with digital images mentioned above.

Sealants

A variety of sealant compositions may be used in the methodology of the present invention to protect the image that has been imparted to the substrate. These compositions may protect the image from abrasion, moisture or humidity, UV degradation, or fingerprints, and may prevent the image from retransferring to other objects. These compositions may also be used advantageously to manipulate the finish of the image, thereby providing an image with a finish that is flat, semi-gloss, gloss, or satin. The exact choice of sealant compositions will depend, in part, on the inks used, the materials of the image receiving layer, and/or the target substrate. However, examples of such compositions include Krylon #1312 spray, also referred to as Kamar Varnish, available from Krylon Products Group, Specialty Division, of the Sherman Williams Co. of Solon, Ohio.

The present invention shall now be illustrated by reference to the following non-limiting examples.

### EXAMPLES

### Example 1

This example illustrates the preparation of a primer for use on solid substrates.

All of the components, with the exception of isopropyl alcohol, were added to an appropriate container. These were stirred until all were dissolved or dispersed in the water. The isopropyl alcohol was then added last and stirred for a short time.

| Component | Percent by Weight: |
|---|---|
| water | 88.82% |
| polyethylene oxide (200,000 molecular weight) | 0.06% |
| polyethylene oxide (600 molecular weight) | 0.04% |
| xylitol | 0.38% |
| hydroxypropylmethyl cellulose | 2.17% |
| colloidal hydrated alumina | 1.15% |
| mordant¹ | 0.60% |
| cationic emulsion² | 1.73% |
| polymethylmethacrylate beads | 0.05% |
| iso-propyl alcohol | 5.00% |

¹The mordant is the compound identified as P. 134-Cl in U.S. Pat. No. 5,342,688.
²3M cationic polymer: 66/30/4 by weight ethyl acrylate/hydroxypropylacrylate/dimethylaminoethylmethacrylate-methylchloride salt

### Example 2

This example illustrates the preparation of a primer for use on solid substrates and was made as above

| Component | Percent by Weight: |
|---|---|
| water | 83.82% |
| polyethylene oxide (200,000 molecular weight) | 0.06% |
| polyethylene oxide (600 molecular weight) | 0.04% |
| xylitol | 0.38% |
| hydroxypropylmethyl cellulose | 2.17% |
| colloidal hydrated alumina | 1.15% |
| mordant¹ | 0.60% |
| cationic emulsion² | 1.73% |
| polymethylmethacrylate beads | 0.05% |
| iso-propyl alcohol | 10.00% |

¹The mordant is the compound identified as P. 134-Cl in U.S. Pat. No. 5,342,688.
²3M cationic polymer: 66/30/4 by weight ethyl acrylate/hydroxypropylacrylate/dimethylaminoethylmethacrylate-methylchloride salt

### Example 3

This example illustrates the preparation of an image transfer sheet in accordance with the present invention.

The carrier film (in roll form) is a silicon-coated, three layered low-density polyethylene/polyethylene terephthalate/high-density polyethylene film obtained from Loparex. The low-density side had been micro-embossed by the 3M Co. to produce a micro-structured film with square dimensions of about ˜200 micrometers×about ˜200 micrometers×about ˜10 micrometers deep thereon.

A knife coater, gapped at 2 mils, was used to coat the following ink-receptive coating solution onto the film. The film was dried by passing it through a 9.14 m, forced air oven set at 77° C. at 7.62 mpm. The coating weight of the dried ink-receptive coating was 1.94 g per square meter.

| Component | Percent by Weight: |
|---|---|
| water | 37.68% |
| polyethylene oxide (200,000 molecular weight) | 0.05% |
| polyethylene oxide (600 molecular weight) | 0.03% |
| xylitol | 0.33% |
| hydroxypropylmethyl cellulose | 1.87% |
| colloidal hydrated alumina | 0.99% |
| mordant¹ | 0.52% |
| cationic emulsion² | 1.49% |
| polymethylmethacrylate beads | 0.04% |
| iso-propyl alcohol | 56.63% |
| Polyoxyethylene Dimethyl Siloxane | 0.16% |
| Glycerol | 0.21% |

¹The mordant is the compound identified as P. 134-Cl in U.S. Pat. No. 5,342,688.
²3M cationic polymer: 66/30/4 by weight ethyl acrylate/hydroxypropylacrylate/dimethylaminoethylmethacrylate-methylchloride salt

### Example 4

This example illustrates the preparation of an image transfer sheet in accordance with the present invention.

The carrier film (roll form) was a silicon-coated, three layered low-density polyethylene/polyethylene terephthalate/high-density polyethylene film obtained from Loparex. The low-density side had been micro-embossed by the 3M Co. to produce a micro-structured film with square dimensions of about ˜200 micrometers×about ˜200 micrometers×about ˜10 micrometers deep thereon (see FIG. 5). A knife coater, gapped at 2 mils, was used to coat the following ink-receptive coating solution onto the film. The film was dried by passing it through a 9.14, forced air oven set at 77° C. at 7.62 mpm. The coating weight of the dried ink-receptive coating was also 1.94 g per square meter.

| Component | Percent by Weight: |
|---|---|
| water | 69.34% |
| polyethylene oxide (200,000 molecular weight) | 0.10% |
| polyethylene oxide (600 molecular weight) | 0.06% |
| xylitol | 0.61% |
| hydroxypropylmethyl cellulose | 3.44% |
| colloidal hydrated alumina | 1.82% |
| mordant¹ | 0.96% |
| cationic emulsion² | 2.73% |
| polymethylmethacrylate beads | 0.07% |
| iso-propyl alcohol | 19.78% |
| Polyoxyethylene Dimethyl Siloxane (Silwet L-7602) | 0.30% |
| Glycerol | 0.79% |

¹The mordant is the compound identified as P. 134-Cl in U.S. Pat. No. 5,342,688.
²3M cationic polymer: 66/30/4 by weight ethyl acrylate/hydroxypropylacrylate/dimethylaminoethylmethacrylate-methylchloride salt

### Example 5

This example illustrate image transfer sheets in accordance with one aspect of the invention.

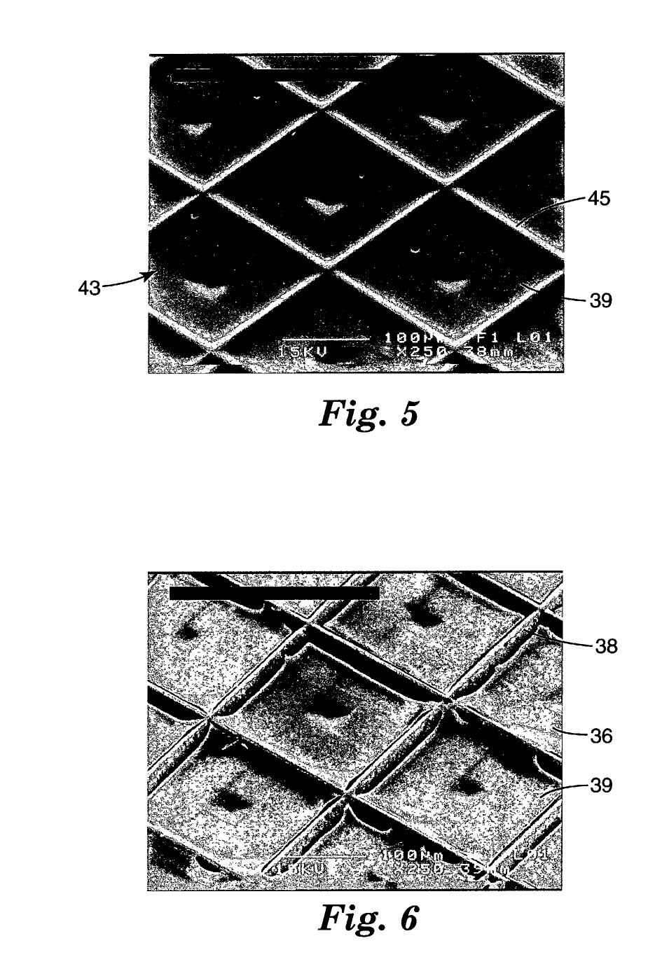

Image transfer sheets were prepared according to Example 4 at dried coating weights of 1.6 and 2.7 gm/m². Scanning electron microscopic images of the two image transfer sheets were then taken. The electron microscopic images can be seen in FIGS. 5 (coating weight 2.7 gm/m²) and 6 (coating weight 1.6 gm/m²). As can be seen by comparing these two images, the same micro-embossed carrier sheet can be used to make either an uninterrupted image transfer sheet (FIG. 5) or an interrupted image transfer sheet (FIG. 6). The features of the image transfer sheets that can be seen in the figures are labeled with the same numbering as were FIGS. 4 and 3, respectively.

### Example 6

This example illustrates an image transferred with an image transfer sheet that has a micro-replicated carrier sheet.

An image transfer sheet was prepared in accordance with Example 4. The particular image to be transferred was chosen, and printed, using a HPdeskjet 940c printer onto the image transfer sheet. The printed image was allowed to dry (the image was dry in about 10 minutes). At some undefined time after the image was printed (the imaged image transfer sheets are generally stable when printed), the imaged portion of the image transfer sheet was cut out, with a few inches of non-imaged image transfer sheet around the edges.

The substrate, a thin piece of sanded (with 320 grit sandpaper from 3M, St Paul, Minn.) basswood, was prepared and wiped clean of dust with a damp cloth and allowed to dry. The substrate was coated, by brushing on a primer solution (at about a dried coating weight of 0.5 gm/m²) prepared as in Example 1. The primer solution was allowed to dry (the primer solution was dry in about 30 minutes). The primed substrates are also generally stable when coated.

The imaged side of the image transfer sheet was placed in contact with the primed substrate and secured using 3M Scotch® tape. A craft stick was then utilized to apply localized pressure to the non-imaged side of the image transfer sheet wherever there was an image on the imaged side of the transfer sheet. Once all of the surface area corresponding to the image had been rubbed with the craft stick, the 3M Scotch®) tape was removed, and the carrier sheet was removed from the substrate. The substrate now contained the vibrant image that was originally printed on the image transfer sheet, on its primed surface.

### Example 7

This example illustrates image transfer sheets and a transferred image in accordance with one aspect of the invention.

An image transfer sheet was prepared according to Example 4. The image was then transferred to a substrate as given in Example 6.

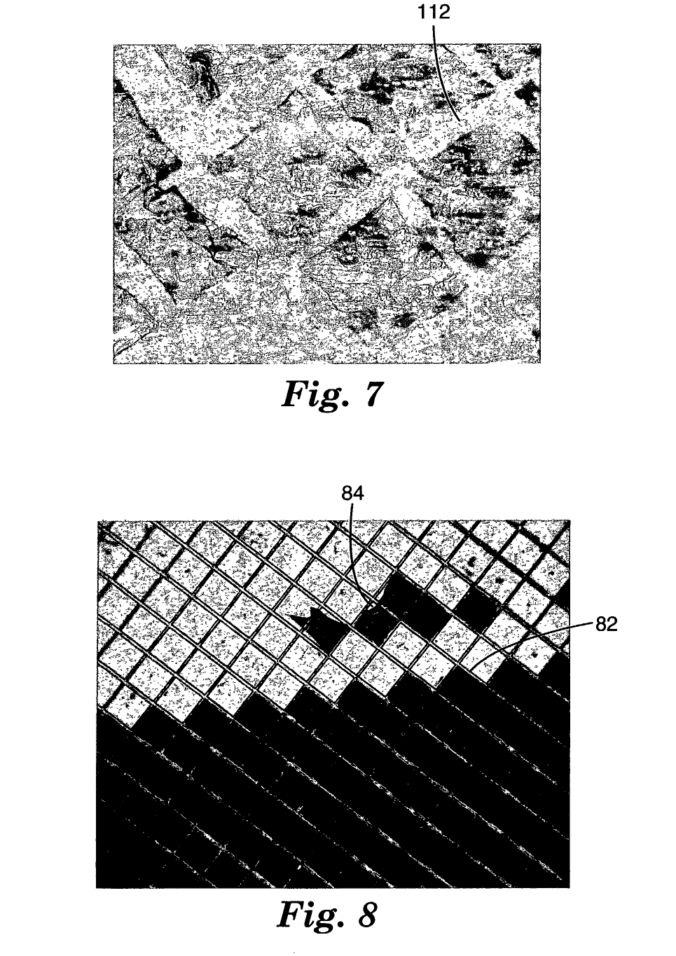

FIG. 7 depicts a microscopic image (magnification of 200×) of the discontinuous transferred image receptive layer on the substrate (basswood). As can be seen therein, once the image receptive layer is transferred to the substrate, it is discontinuous, i.e., it contains at least one physical separation 112.

FIG. 8 depicts a microscopic image of the image transfer sheet after a portion of the imaged image transfer layer has been transferred to the substrate. As can be seen therein, the noninterrupted friable image receptive layer can either create physical separations corresponding to the pattern of the coated image receptive layer (82 designates one of these physical separations) or it can fracture based on where pressure was applied within one tile of the image receptive layer (84 designates one of these physical separations).

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

What is claimed is:

1. An article for transferring an image to a substrate comprising:
(a) a carrier sheet with a top and a bottom surface;
(b) an interrupted image receptive layer releasably attached to the top surface of the carrier sheet.

2. The article of claim 1, wherein the carrier sheet is micro-embossed.

3. The article of claim 2 wherein the carrier sheet has micro-embossed elements that are wells where the wells have a depth of from about 5 to about 100 micrometers.

4. The article of claim 2, wherein the carrier sheet has micro-embossed elements that are wells where the wells have a depth of from about 10 to about 25 micrometers.

5. The article of claim 3, wherein the image receptive layer comprises tiles that are within the wells.

6. The article of claim 1, wherein the image receptive layer is friable.

7. The article of claim 4, wherein the image receptive layer is coated onto the carrier sheet at a dried coating of weight of about 1 to about 2 gm/m².

8. The article of claim 1, wherein the image receptive layer comprises image receptive layer material pattern coated onto the carrier sheet.

9. An article for transferring an image to a substrate comprising:
(a) a carrier sheet with a top and a bottom surface;
(b) an uninterrupted friable image receptive layer releasably attached to the top surface of the carrier sheet.

10. The article of claim 9, wherein the carrier sheet is micro-embossed.

11. The article of claim 10, wherein the carrier sheet has micro-embossed elements that are wells where the wells have a depth of from about 5 to about 100 micrometers.

12. The article of claim 11, wherein the carrier sheet has micro-embossed elements that are wells where the wells have a depth of from about 10 to about 25 micrometers.

13. The article of claim 12 wherein the image receptive layer is coated onto the carrier sheet at a dried coating of weight of about 2 to about 3.7 gm/m².

14. A method for imparting an image to a substrate, comprising the steps of:
(a) imparting an image to an image transfer sheet that comprises an image receptive layer releasably attached to a carrier sheet, wherein the imaged side of the image transfer sheet is the side containing the image, and the non-imaged side is the other side;
(b) contacting the imaged side of the image transfer sheet with the substrate;
(c) applying localized pressure to the non-imaged side of the image transfer sheet; and
(d) removing the carrier sheet
wherein removal of the carrier sheet imparts the portion of the imaged image receptive layer, as a discontinuous layer, where localized pressure was applied to the non-imaged side of the image transfer sheet.

15. The method of claim 14, wherein the image is applied to the image transfer sheet using inkjet printing techniques.

16. The method of claim 14, wherein the image is applied to the image transfer sheet using water-based or solvent markers.

17. The method of claim 14, wherein the image is applied to the image transfer sheet using a brush, stamp or roller.

18. The method of claim 14, further comprising coating a surface of the substrate with a primer.

19. The method of claim 18, wherein the primer is an ink receptive solution.

20. The method of claim 14, further comprising applying an adhesive to the imaged side of the imaged image transfer sheet before it is transferred to the substrate.

21. The method of claim 14, further comprising applying an adhesive to the substrate before the image is transferred.

22. The method of claim 14, further comprising coating the transferred image on the substrate with a sealant composition.

23. A product made in accordance with the method of claim 14.

24. A kit for transferring an image to a substrate comprising an image transfer sheet that comprises an image receptive layer and a carrier sheet wherein the image receptive layer and the carrier sheet are configured to transfer the image receptive layer, as a discontinuous layer, to the substrate.

25. The kit of claim 24, wherein the carrier sheet is micro-embossed.

26. The kit of claim 25, wherein the carrier sheet has micro-embossed elements that are wells where the wells have a depth of from about 5 to about 100 micrometers.

27. The kit of claim 25, wherein the carrier sheet has micro-embossed elements that are wells where the wells have a depth of from about 10 to about 25 micrometers.

28. The kit of claim 25, wherein the image receptive layer comprises tiles that are within the wells.

29. The kit of claim 24, wherein the image receptive layer is friable.

30. The kit of claim 29, wherein the image receptive layer comprises a humectant.

31. The kit of claim 30, wherein the humectant comprises glycerol.

32. The kit of claim 27, wherein the image receptive layer is coated onto the carrier sheet at a dried coating of weight of about 2 to about 3.7 gm/m².

33. The kit of claim 27 wherein the image receptive layer is coated onto the carrier sheet at a dried coating of weight of about 1 to about 2 gm/m².

34. The kit of claim 24, further comprising a primer for application to the substrate before the image is transferred.

35. The kit of claim 24, further comprising an adhesive composition.

36. The kit of claim 35, wherein the adhesive is to be applied to the printed image transfer sheet before transfer.

37. The kit of claim 35, wherein the adhesive is to be applied to the substrate before transfer of the image.

38. The kit of claim 24, wherein the image transfer sheet further comprises an image printed onto the image transfer sheet.

39. The kit of claim 24, further comprising a sealant for application to the transferred image receptive layer.
